(19) United States
(12) Patent Application Publication
(10) Pub. No.: US 2002/0087486 A1
(43) Pub. Date: Jul. 4, 2002

(54) Integrated bargaining process and apparatus

(76) Inventor: Tomas D. Posey, Alpharetta, GA (US)

Correspondence Address: Donald R. Palladino, Kirkpatrick & Lockhart LLP, 535 Smithfield Street, Pittsburgh, PA, 15222, US

(21) Appl. No.: 09/752,151

(22) Filed: Dec. 29, 2000

(51) Int. Cl. G06F 17/60; H04L 9/00; H04K 1/00

(52) U.S. Cl. 705/80; 705/7

(57) ABSTRACT

An integrated bargaining process wherein a proposal to modify a contract is compared to a business plan, and a relations strategy if the proposal is consistent with the business plan. If the proposal is consistent with the relations strategy, a bargaining strategy is developed to bargain the proposal. The proposal is bargained through a continuous bargaining process that may consist of a board that includes members of all parties to the contract. If the proposal can be implemented without negotiation of a new contract or renegotiation of an existing contract, then the proposal is bargained into the existing contract and implemented. A computer program that implements the process is also provided.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to a method of continuous bargaining. In particular, the present invention relates to an integrated bargaining process that has the benefit of, among other things, allowing the parties to a contract to quickly and appropriately adjust to changing business conditions through joint decision making without waiting for the term of a contract to expire.

2. Description of the Invention Background

Historically, bargaining professionals have not been provided with an integrated bargaining system that provides a method by which a bargaining strategy can be assured to be consistent with business needs and relations strategies. As a result, bargainers are often left unaware of how a bargaining strategy, which may consist of merely a “laundry list” of items to be gained in the bargaining process, related to current business needs and current relations strategies.

Prior art bargaining instructional materials, such as those provided in college-level strategic bargaining courses, deal primarily with bargaining behaviors, i.e., “table manners.” For example, such materials often discuss issues such as bargaining room structure, number of bargainers, and the like.

More advanced bargaining courses may instruct the bargainer as to how to determine the best alternative to a negotiated agreement (“BATNA”). Under this process, the bargainer can compare the cost of a proposal to the party it represents in comparison with the cost of a counter-proposal. Such materials, however, fall short in that they fail to consider how proposals and counter-proposals impact other areas, such as a business plan and a relations strategy.

Thus, it is desirable to provide a method of integrated bargaining that enables the bargainer to ensure that bargaining proposals are consistent with a business plan and a relations strategy. It is also desirable to provide an integrated bargaining process that allows the parties to a contract to quickly and appropriately adjust to changing business conditions through joint decision making without waiting for the term of the contract to expire.

### SUMMARY OF THE INVENTION

The present invention relates to an integrated bargaining process between a party and at least one other party that provides the capability of modifying a contract during the term of the contract. The process may be used, for example, in relations between a business and a labor union. The process also acts to improve relations between the parties and allows the parties to quickly adjust to changing business conditions. Also, the integrated bargaining process of the present invention may be embodied in the form of a computer program.

According to the integrated bargaining process of the present invention, there is provided a business planning module, a relations strategy module, a bargaining strategy module, a continuous bargaining module, and an operations module. A proposal for a contract modification may enter the process at any one of the business planning module, the continuous bargaining module, and the operating module. The proposal may be introduced into the process by any of the parties to the contract.

The process of the present invention contemplates that the proposal is compared to a business plan that is developed by the business planning module. The business plan addresses broad business issues and ensures that the proposal is consistent with the overall business goals prior to implementation. The business planning module may comprise a committee, such as a business planning committee that includes members of a corporate management team.

If it is determined that the proposal is consistent with the business plan, then the proposal is compared to a relations strategy. The relations strategy is based on the business plan but may be more specific and may include consideration of contract structure, economic conditions, and the relationship of the parties.

If it is determined that the proposal is consistent with the relations strategy, a bargaining strategy may then be developed. The bargaining strategy may be developed by a bargaining strategy module, and may address specific issues that will enable bargaining of the proposal between the parties. For example, the bargaining strategy may address factors such as bargaining structure, contract structure, bargaining objectives, timing, communications, and contingencies.

Next, according to the process of the present invention, the proposal may be submitted to a continuous bargaining module that may consist of, for example, a joint board comprising members from all parties to the contract. This board, or a similar entity, may then determine whether the proposal may be negotiated, incorporated, and implemented under an existing contract or whether the proposal would require renegotiation of an existing contract or negotiation of a new contract. If the proposal requires renegotiation or negotiation of a new contract, then the proposal exits the process of the present invention and is dealt with according to those processes. On the other hand, if the proposal can be implemented without such procedures, then the continuous bargaining module negotiates the proposal into a modification of an existing contract. The modification may then be implemented by an operations module that may also provides feedback to the business planning module.

The present invention, therefore, provides an integrated bargaining method that allows the parties to a contract to quickly and appropriately adjust to changing business conditions through joint decision making without necessarily waiting for the term of the contract to expire, thus improving rapport and fostering a mutually beneficial relationship between the parties.

### BRIEF DESCRIPTION OF THE DRAWINGS

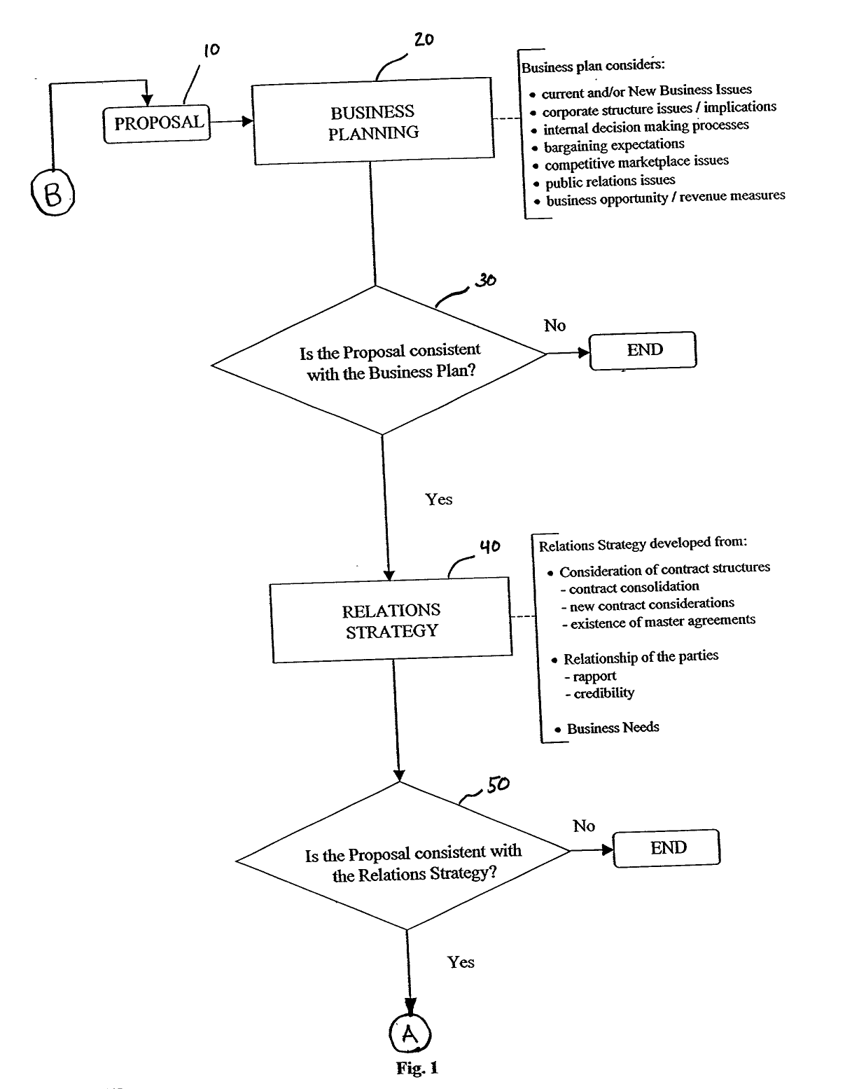

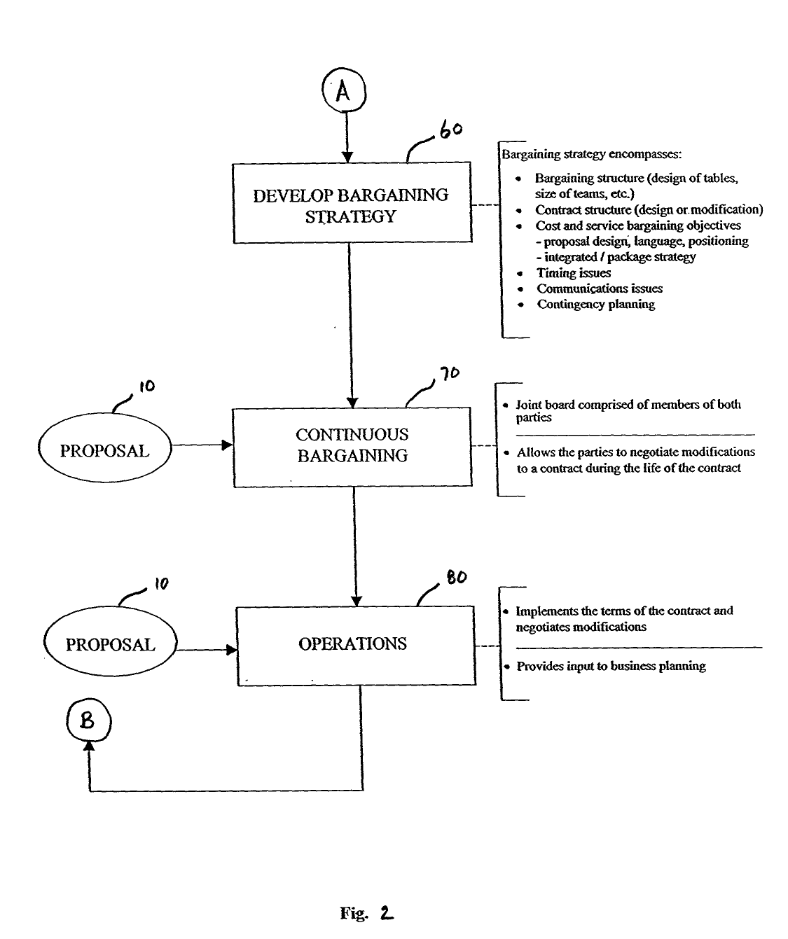

The accompanying FIGS. 1 and 2 depict a flowchart of an embodiment of the integrated bargaining process of the present invention.

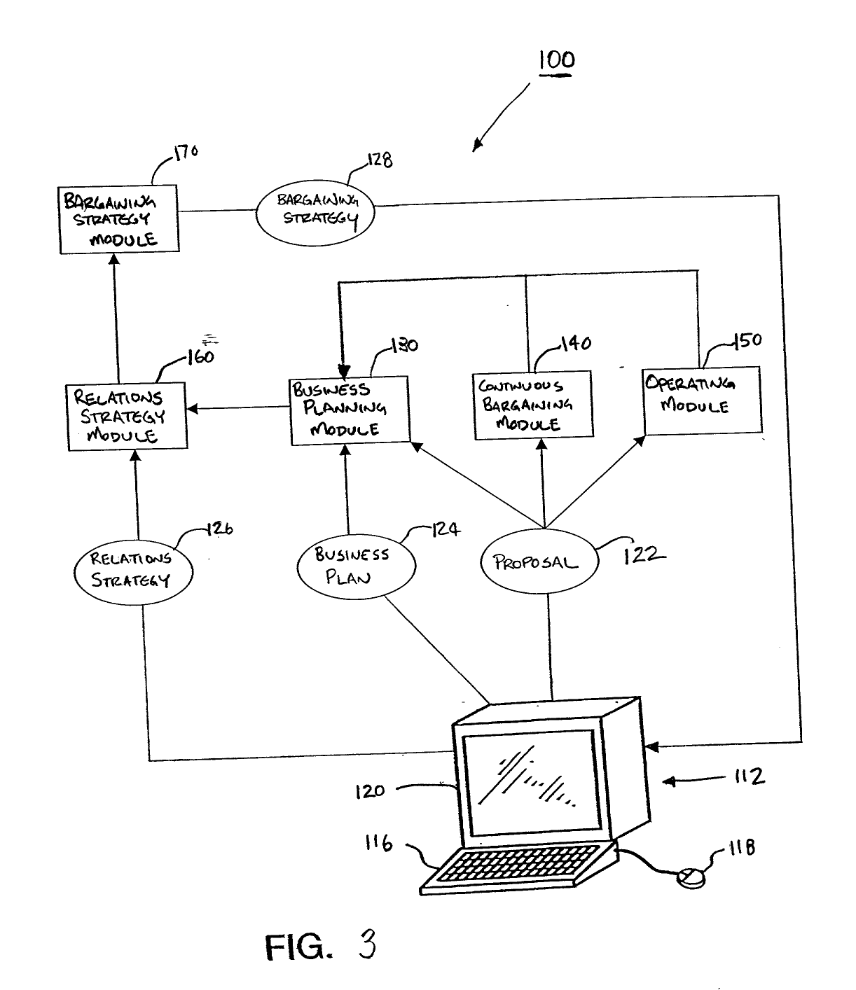

The accompanying FIG. 3 depicts an embodiment of the integrated bargaining apparatus of the present invention.

### DETAILED DESCRIPTION OF THE INVENTION

Referring now to FIG. 1 there is depicted an embodiment of the integrated bargaining process of the present invention. The integrated bargaining process between a party and at least one other party of the present invention provides the capability to modify a contract during the term (or life) of the contract. The process has the benefit of, among other things, allowing the parties to adjust to changing business conditions through joint decision making without waiting for the term of the contract to expire. This assists in improving rapport between the parties and fostering a mutually beneficial relationship between the parties. The integrated bargaining process of the present invention may be incorporated, for example, between a business and a labor union.

As is apparent, a proposal 10 for a contract modification may enter the integrated bargaining process at any one of three modules (or processes). These include the business planning module 20, the continuous bargaining module 70, and the operating module 80. Such a proposal 10 may be presented by any one of the parties to the contract.

Initial analysis of the proposal is conducted by the business planning module 20, which may take the form of, for example, a business planning committee. This analysis consists of a comparison of the proposal to a business plan that is developed by the business planning module. The business plan addresses broad business issues and may consist of, for example, an analysis of whether the proposal is consistent with the current business, and proposed new businesses. The business plan may also consider, for example, the corporate structure, internal decision making processes, the competitive marketplace, public relations issues, and business productivity/revenue measures.

If the proposal 10 is consistent with the business plan 30 as developed by the business planning module, then the proposal 10 is forwarded to the relations module 40. The relations module 40 develops a relations strategy between the party and the other parties to the contract. This relations strategy 40 is based, at least in part, on the business plan that is developed by the business planning module 20. In addition to business needs, the relations strategy 40 addresses issues such as, for example, contract structure, wherein factors such as contract consolidation, new contract considerations, and the existence of a master agreement are taken into account. The relations strategy 40 may also be developed based on additional factors, such as, for example, economic conditions and the relationship of the parties. The latter factor may take into account, for example, rapport and credibility issues.

Referring now to FIG. 2, it is seen that if the proposal 10 is consistent with both the business plan 30 and the relations strategy 50, a bargaining strategy 60 is developed for the purpose of bargaining the proposal into the contract. The bargaining strategy 60 flows from, or is based upon, the relations strategy 40, which, in turn, is based on the business plan 30. The bargaining strategy 60 may be developed by a bargaining strategy module and may relate to many issues, such as a bargaining structure that addresses issues such as, for example, the size of the bargaining team and the design of bargaining tables. The bargaining strategy 60 may also relate to contract structure, which may relate to contract design or modification such as, for example, whether a single all-encompassing contract is appropriate or whether several narrowly directed contracts are preferred. The bargaining strategy 60 may also address bargaining objectives. This factor addresses issues such as, for example, proposal design, proposal language, and trading strategy. The bargaining strategy 60 may also take into account timing considerations, communications planning, and a contingency plan in the event that the proposal is not acceptable to the other party. In the case of a labor union, the contingency plan may comprise strike contingency planning.

Once the bargaining strategy 60 has been developed, the proposal 10 may be submitted to the continuous bargaining module 70. The purpose of the continuous bargaining module 70 is to provide a method of negotiating contract modifications during the life of an existing contract. Generally, it is expected that proposals 10 that are incorporated into an existing contract will relate to routine specific components of a contract that do not warrant negotiation of a new contract. The continuous bargaining module 70 may consist of, for example, a board that comprises representatives of the parties to the contract. For example, when the parties to the contract consist of a business and a labor union, the board may be comprised of members from both the company and the union.

Either party may submit proposals 10 for contract modifications to the continuous bargaining module 70. For example, when the parties are a business and a labor union, a proposal 10 for contract modification may be submitted to the continuous bargaining module 70 by either the union or the business. The continuous bargaining module 70 determines whether the proposal 10 can be implemented without the need to renegotiate an existing contract or without negotiating a new contract. If so, the continuous bargaining module negotiates 70 the proposal 10 into the existing contract, and the proposal 10 is implemented by an operating module 80. In addition to implementing the modifications, the operating module 80 may also make proposals 10 for modifications to the business planning module 20. On the other hand, if the continuous bargaining module 70 determines that the proposal 10 cannot be implemented without negotiating a new contract or renegotiating an existing contract, then the proposal 10 is tabled for future consideration, discarded, or addressed in accordance with those procedures.

Now referring to FIG. 3, it is seen that the integrated bargaining process between a party and at least one other party of the present invention may also be embodied in a system 100. According to this embodiment, a computer program may be stored in a computer-readable storage medium for execution by a computer 112, such as a computer disk, wherein the computer comprises a processor (not shown), a data storage system (not shown), at least one input device such as, for example, a keyboard 116 and a mouse 118, and at least one output device such as, for example, a monitor 120. The system 100 of the present invention provides the capability to modify a contract during the term (or life) of the contract, wherein the modification is based on a proposal 122 that is input into the computer 112 by a user (not shown). For example, where the parties to the contract include a business and a labor union, either the union or the business may provide the proposal 122.

Aside from the proposal 122, a user may also input certain other information into the system 100. First, a business plan 124 may be input into the system 100 by a user. Also, a relations strategy 126 may be entered. The business plan 124 addresses the broad business issues described earlier, while the relations strategy 126 addresses, in addition to business needs, the issues described earlier such as, for example, contract structure, economic conditions and party relationship. These entries allow the system 100 to formulate and output a bargaining strategy 128 that may be used to implement the proposal 122 entered by the user.

The system 100 of the present invention operates as follows. First, the system 100 provides instructions, via the business planning module 130, for comparing the proposal 122 entered by the user, through any of the business planning module 130, a continuous bargaining module 140, or an operating module 150, to the business plan 124 that is also entered into the system 100 (the business plan 124 may be entered prior to or simultaneously with the proposal 122 and may be entered by the same or a different user). Where the proposal 122 is consistent with the business plan 124, the system 100 provides instructions, via the relations strategy module 160, for comparing the proposal 122 to the relations strategy 126 that is also entered into the system 100 (the relations strategy 126 may also be entered prior to or simultaneously with the proposal 122 and may also be entered by the same or a different user).

Finally, where the proposal 122 is consistent with both the business plan 124 and the relations strategy 126, the system 100 provides instructions, via the bargaining strategy module 170, for generating a bargaining strategy 128 for implementation of the proposal 122. The bargaining strategy 128, as described earlier, may address many issues including, for example, a bargaining structure that addresses issues such as, for example, the size of the bargaining team and the design of bargaining tables. The bargaining strategy 128 may also address contract structure, which may relate to contract design or modification such as, for example, whether a single all-encompassing contract is appropriate or whether several narrowly directed contracts are preferred. The bargaining strategy 128 may also address bargaining objectives. This factor addresses issues such as, for example, proposal design, proposal language, and trading strategy. The bargaining strategy 128 may also take into account other issues, such as timing considerations, communications planning, and a contingency plan in the event that the proposal is not acceptable to the other party. In the case of a labor union, the contingency plan may comprise strike contingency planning.

The bargaining strategy 128 generated by the system 100 of the present invention may then be sent to the output device 120 where it may then be used to negotiate the proposal into a contract modification and, where successful, the modification may be implemented by the operations module 150.

It is to be understood that the present description illustrates aspects of the invention relevant to a clear understanding of the invention. Certain aspects of the invention that would be apparent to those of ordinary skill in the art and that, therefore, would not facilitate a better understanding of the invention may not have been presented in order to simplify the present description. Although the present invention has been described in connection with certain embodiments, those of ordinary skill in the art will, upon considering the foregoing description, recognize that many modifications and variations of the invention may be employed. The foregoing description and the following claims are intended to cover all such variations and modifications of the invention.

I claim:

1. An integrated bargaining method comprising:
submitting a proposal for a modification of a contract during the term of the contract;
comparing the proposal to a business plan;
comparing the proposal to a relations strategy if the proposal is consistent with the business plan;
developing a bargaining strategy to negotiate the modification if the modification is consistent with the relations strategy;
negotiating the modification; and
implementing the modification.

2. The method of claim 1 wherein the proposal is submitted to at least one of a business planning module, a continuous bargaining module, and an operating module.

3. The method of claim I wherein a business planning module compares the proposal to the business plan.

4. The method of claim 3 wherein the business planning module provides the proposal to a relations strategy module if the proposal is consistent with the business plan.

5. The method of claim 1, wherein a relations strategy module compares the proposal to the relations strategy.

6. The method of claim 5 wherein the relations strategy module provides the proposal to a bargaining strategy module if the proposal is consistent with the relations strategy.

7. The method of claim 1 wherein a bargaining strategy module develops the bargaining strategy and provides it to a continuous bargaining module.

8. The method of claim 7 wherein the continuous bargaining module negotiates the modification.

9. The method of claim 1 wherein an operating module implements the modification.

10. The method of claim 1 wherein the party is a business.

11. The method of claim 1 wherein the at least one other party is a labor union.

12. The method of claim 1 wherein the business planning module comprises a committee.

13. The method of claim 1 wherein the business planning module develops the business plan based on analysis of at least one of a current business factor, a new business factor, a corporate structure factor, an internal decision making process factor, a bargaining expectations factor, a competitive marketplace factor, a business productivity measure factor, a revenue measure factor, and a public relations factor.

14. The method of claim 1 wherein the relations strategy comprises a labor relations strategy.

15. The method of claim 1 wherein the relations strategy module develops the relations strategy based on analysis of at least one of contract structures, a relationship between the party and the at least one other party, and an economic environment.

16. The method of claim 1 wherein the bargaining strategy comprises at least one of a bargaining structure, a contract structure, a bargaining objective, a contingency plan, and a communication plan.

17. The method of claim 1 wherein the continuous bargaining module comprises a board comprising representatives of the party and the at least one other party.

18. The method of claim 17 wherein the party is a business.

19. The method of claim 17 wherein the at least one other party is a labor union.

20. The method of claim 1 wherein the proposal is provided by at least one of the party and the at least one other party.

21. The method of claim 20 wherein the party is a business.

22. The method of claim 20 wherein the at least one other party is a labor union.

23. A computer program for an integrated system of bargaining between a party and at least one other party, the program being stored on a computer-readable storage medium for execution by a computer, the computer comprising a processor, a data storage system, at least one input device, and at least one output device, wherein the program provides the capability to modify a contract during a term of the contract, wherein the modification is based on a proposal that is inputted into the computer program by a user, and wherein the computer program comprises:
instructions for comparing the proposal to a business plan;
instructions for comparing the proposal to a relations strategy if the proposal is consistent with the business plan; and
instructions for generating a bargaining strategy if the proposal is consistent with the relations strategy.

24. The computer program of claim 23 wherein the instructions for comparing the proposal to a business plan comprises a business planning module.

25. The computer program of claim 23 wherein the instructions for comparing the proposal to a relations strategy comprises a relations strategy module.

26. The computer program of claim 23 wherein the instructions for generating a bargaining strategy comprises a bargaining strategy module.

27. The computer program of claim 23 wherein the party is a business.

28. The computer program of claim 23 wherein the at least one other party is a labor union.

29. The computer program of claim 23 wherein a user may input the business plan into the computer program.

30. The computer program of claim 23 wherein the business plan accounts for at least one of a current business factor, a new business factor, a corporate structure factor, an internal decision making process factor, a bargaining expectations factor, a competitive marketplace factor, a business productivity measure factor, a revenue measure factor, and a public relations factor.

31. The computer program of claim 23 wherein the relations strategy comprises a labor relations strategy.

32. The computer program of claim 23 wherein a user may input the relations strategy into the computer program.

33. The computer program of claim 23 wherein the relations strategy accounts for at least one of contract structures, a relationship between the party and the at least one other party, and an economic environment.

34. The computer program of claim 23 wherein the program outputs the bargaining strategy to a user.

35. The computer program of claim 23 wherein the bargaining strategy comprises at least one of a bargaining structure, a contract structure, a bargaining objective, a contingency plan, and a communication plan.

36. The computer program of claim 23 wherein the proposal is provided by at least one of the party and the at least one other party.

37. The computer program of claim 36 wherein the party is a business.

38. The computer program of claim 37 wherein the at least one other party is a labor union.
